(19) United States
(12) Patent Application Publication
(10) Pub. No.: US 2005/0025251 A1
(43) Pub. Date: Feb. 3, 2005

(54) Method of optimizing compression rate in adaptive differential pulse code modulation (ADPCM)

(76) Inventors: Yuh-Chin Chang, Hsinchu (TW); Hui-Ya Chou, Hsinchu (TW); Peng-Cheng Chen, Hsinchu (TW); Hong-Tsan Lee, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/660,504

(22) Filed: Sep. 12, 2003

(30) Foreign Application Priority Data
Jul. 28, 2003 (TW) 092120497

(51) Int. Cl. H04B 14/06

(52) U.S. Cl. 375/246

(57) ABSTRACT

A method of optimizing the compression rate in Adaptive Differential Pulse Code Modulation (ADPCM) is disclosed. The modified pulse code modulation technique employs a prognostic code converter to generate variable length codes on top of the ADPCM coding, based on the probability of occurrence of data bits in a data sample. This variable-length coding is able to further reduce the compressed data size by increasing the compression rate of the conventional ADPCM coding.

### BACKGROUND OF THE INVENTION

1. Field of the Invention

The present invention relates to a method of optimizing the compression rate in Adaptive Differential Pulse Code Modulation (ADPCM), especially to a modified pulse code modulation technique that employs a prognostic code converter to generate variable length codes on top of the ADPCM coding, based on the probability of occurrence of data bits, so as to further reduce the compressed data size and to increase the compression rate of the conventional ADPCM coding.

2. Description of Related Arts

The main difference between the pulse code modulation (PCM) and the Adaptive Differential Pulse Code Modulation (ADPCM) lies in the compression format, where the PCM coding is mainly used to convert analog signals to digital signals in the audio signal processing using a fixed sampling frequency. This PCM coding has the advantage of realistic sound reproduction, but a large memory is required for such operation. ADPCM coding is an adaptive coding technique that incorporates an adaptive predictor in the compression coding process to produce compressed data with suitable compression rate. For example, a 16-bit data sample can be compressed according to a 4:1 ratio to a 4-bit data sample; and conversely, the compressed data can be decompressed according to a 1:4 ratio to restore it to the original signal waveform of a 16-bit string.

The application of ADPCM for compressing audio and speech signals is aimed at easing the transmission bandwidth and reducing the memory storage requirements. However, the main disadvantage of ADPCM lies in the low compression rate. Although the memory requirements for the ADPCM codes are fewer than those for the PCM codes, the compression rate is still not sufficient to meet the memory requirements for portable electronic devices, for example CD players.

From numerous observations, it is found that data contents in adjacent data blocks are subject to less variation than non-adjacent data blocks. If the locality of data in the compression coding can be analyzed, the compression rate can be further improved, A modified pulse code modulation technique based on Huffman coding can be employed by first creating a look-up table with variable length codes that match the occurrence rate of data bits. This modified pulse code modulation process, using variable-length or run-length coding, can be a second-level coding process on top of the conventional ADPCM for achieving a higher compression rate in the audio signal processing.

In general, both coding techniques have been used in digital signal processing. For example, a portable CD player may be installed with an electronic anti-shock system (EASS) to maintain constant quality of audio output and to create a buffering effect against physical vibrations of the CD player. The electronic anti-shock system (EASS) shown in FIG. 4 with a single output channel has an ADPCM encoder (71) on the front end and an ADPCM decoder (73) on the back-end. The ADPCM encoder (71) is used to generate ADPCM codes from input data samples which are then saved in the random access memory (72); and conversely, the compressed data retrieved from the random access memory (72) are processed by the ADPCM decoder (73) for decoding the ADPCM codes to the original waveform of audio signals en route to an audio signal processor (74) for audio output.

The compression coding for the above-mentioned ADPCM encoder (71) can be both a 4-bit mode and 3-bit mode. Since all current audio equipment has at least two audio channels, the 4-bit operation mode is selected in this example for calculation of the bit rate with a sampling frequency of 44.1 KHz:
4(bits)×44100×2(number of audio channels)=352,800 Kbps

If the operation is in 3-bit operation mode, the bit rate is:
3(bits)×44100×2(number of audio channels)=264,600 Kbps

If the memory capacity in the above anti-shock buffering system is 16M, Bits, as in the present example, the required buffering time for the two operation modes can be:
4-bit mode: 16,000,000÷352,800=45.35 (sec)
3-bit mode: 16,000,000÷264,600=60.46 (sec)

From the foregoing, it is apparent that the bit rate and the memory capacity directly affects the buffering time of the EASS. Since the data saving operation in the EASS has to be sustained for certain time period in order to create an anti-shock buffering effect, and the buffering time is dependent on the compression rate in the coding process and the capacity of random access memory used, the performance of an ADPCM-based CD player embedded with EASS can also be affected.

However, the main disadvantage of ADPCM lies in the low compression rate, as the resulting compression rate of the conventional ADPCM is not enough for efficient utilization of random access memory as in the case of the ADPCM-based CD players. There are some more advanced compression algorithms, such as the MPEG/layer I and II, which are able to produce reasonably good sound quality using much less memory than ADPCM.

Under the precondition not to increase random access memory, the only way to improve the performance of EASS for ADPCM-based CD players, without incurring additional hardware costs, is to increase the bit rate in the compression process. If the compression rate of ADPCM is increased, the performance of EASS can be improved with lossless code modulation. Another benefit of EASS is the power saving consideration for portable CD players as the longer the CD servo can be suspended by the buffering effect, the less system power is used.

### SUMMARY OF THE INVENTION

The main object of the present invention is to provide a method of optimizing the compression rate in Adaptive Differential Pulse Code Modulation (ADPCM) that uses variable length coding based on the probability of occurrence of data bits to further reduce the size of compressed data and improve the performance over conventional adaptive differential pulse code modulation (ADPCM).

To this end, the modified pulse code modulation technique employs a prognostic code converter to generate variable length codes on top of the adaptive differential pulse code modulation (ADPCM) coding. Variable length codes are generated according to the probability of occurrence of the data bits. In the variable length coding process, a bit string with the highest occurrence rate will be assigned a variable length code with the shortest length, whereas the bit string with the lowest occurrence rate will be assigned variable length code with the longest length. Conversely, when decoding, the compressed data is first processed by a variable length decoder to reconstruct the pure ADPCM coding and then to the original audio signal in a lossless audio signal processing.

The features and structure of the present invention will be more clearly understood when taken in conjunction with the accompanying figures.

### BRIEF DESCRIPTION OF THE DRAWINGS

FIG. 1 is system architecture of the present invention;

FIG. 2 is an example of the probability table of the occurrence of bit strings in a certain data block;

FIG. 3 is a table of the variable length codes matching the probability of occurrence of data bits; and

FIG. 4 is a block diagram of the conventional electronic anti-shock system (EASS).

### DETAILED DESCRIPTION OF THE PREFERRED EMBODIMENT

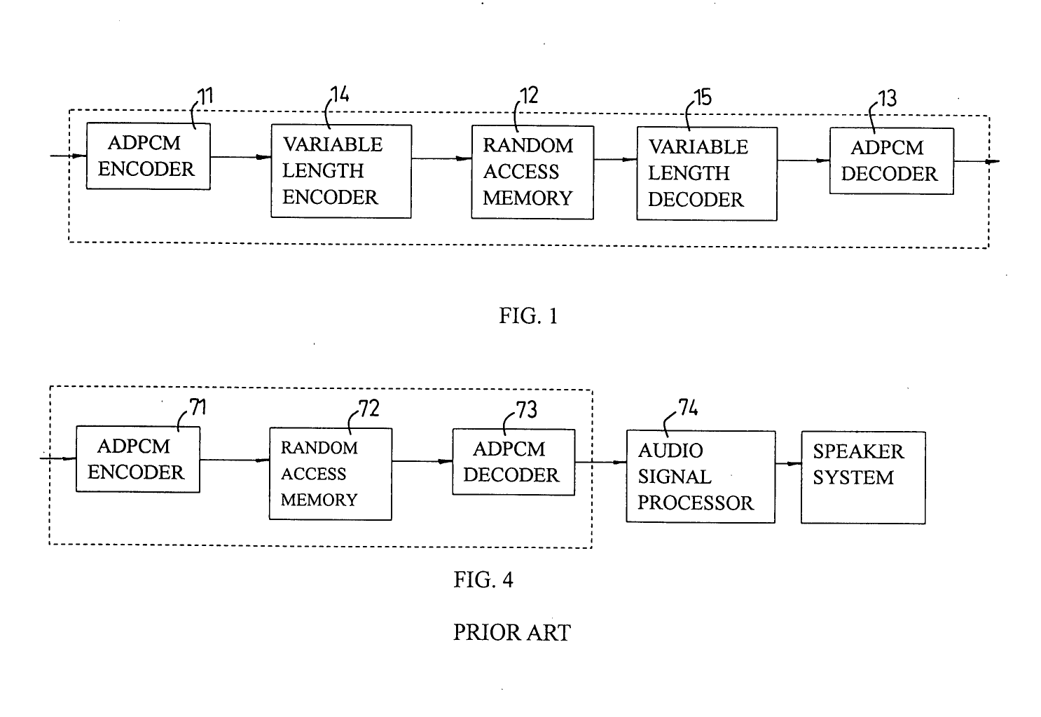

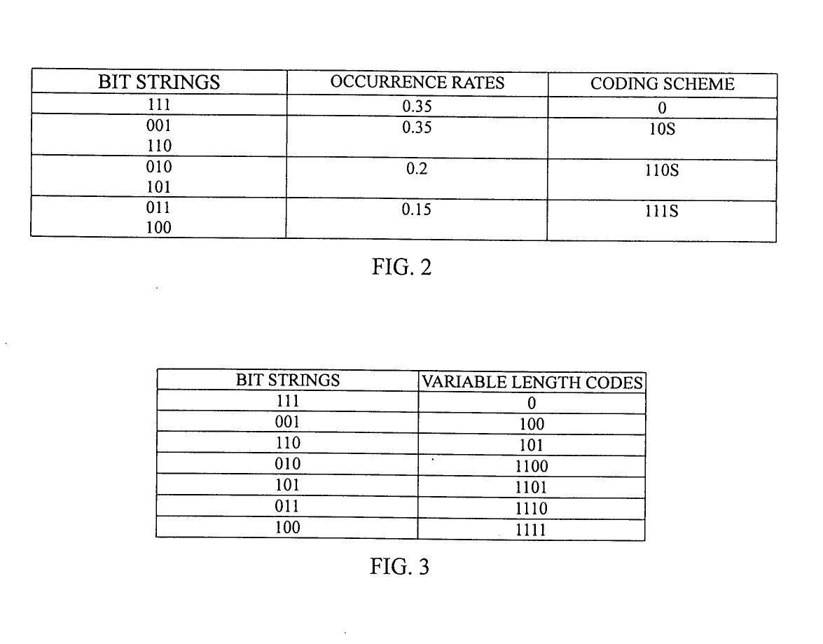

The present invention provides a method of optimizing the compression rate in a adaptive differential pulse code modulation (ADPCM) by employing a prognostic code converter with a system architecture as shown in FIG. 1, comprising:
an ADPCM encoder (11) for encoding with an ADPCM coding technique;
a random access memory (12) for temporary saving of output codes from the ADPCM encoder (11) to provide a buffering effect;
an ADPCM decoder (13) for restoring the compressed ADPCM codes retrieved from the random access memory (12) to the original audio signals;
a variable-length encoder (14), which is installed in between the ADPCM encoder (11) and the random access memory (12), for modulating the variable length codes on top of the ADPCM coding, in accordance with the probability of occurrence of data bits en route to the random access memory (12); and
a variable-length decoder (15), which is installed in between the random access memory (12) and ADPCM decoder (13), for decoding the variable length codes retrieved from the random access memory (12) to the original ADPCM codes, and then passing on to the ADPCM decoder (13) for restoring to the original audio signals.

Applying this model to the example of an electronic anti-shock system (EASS) embedded in ADPCM-based CD players, the variable length encoder (14) is installed in between the ADPCM encoder (11) and the random access memory (12) to further compress ADPCM codes before being saved in the memory, whereby the data storage capacity of the memory can be increased and the buffering time can be extended. Conversely, when the compressed data are retrieved from the random access memory (12), the compressed data are first converted back to ADPCM codes and then to the original audio signals for lossless audio performance.

The detailed operation of the variable length encoder (11) and decoder (13) are to be explained in the following paragraphs.

The variable length encoder is based on the Huffman coding scheme, whereby pulse codes with the same length bit strings can be converted to variable length codes according to the probability of occurrence of data bits. A variable length code is designed to correspond to the original ADPCM code, but the size of the compressed code is substantially less than a pure ADPCM code. In the Huffman coding scheme, the bit string with the highest occurrence rate will be assigned the variable length code with the shortest length, whereas the bit string with the lowest occurrence rate be assigned the variable length code with the longest length. An example of ADPCM coding is given below using the 3-bit ADPCM mode.

In the 3-bit coding mode, the patterns of bit strings are defined as:
001 010 011 100 101 110 111

The probability of occurrence in a data block are in an ascending order as follows 111, 001, 110, 010, 101, 011, and 100, where the occurrence of 111 has a 0.35 probability; 001 and 110 have a 0.3 probability; 010 and 101 have a 0.2 probability; 011 and 100 has a 0.15 probability. Basing on the list of probability of occurrence, the bit string with the highest occurrence rate is assigned a variable length code represented by one data bit “0” to replace the original ADPCM code; the bit string with the second highest occurrence rate is then assigned a variable length code formed by three data bits “10S” (where S being the most significant bit); and the third and fourth highest occurrence rates are respectively assigned three bits codes of 110S and 111S respectively. The conversion table for all variable length codes is shown in FIG. 3. To demonstrate the effect of such a conversion process, a block of data is selected for comparing compressed data before and after the variable length coding process.

Assuming the original ADPCM codes are represented by:
011_{—}010_{—}001_{—}111_{—}001_{—}110_{—}111_{—}111_{—}001_{—}110_{—}001_{—}110_{—}111

The above data block occupies 39 bits, and then the variable length codes are generated on top of the ADPCM coding in accordance with the present invention, the contents of the data block being:
1110_{—}1100_{—}100_{—}0_{—}100_{—}101_{—}0_{—}0_{—}100_{—}101_{—}100_{—}101_{—}0
and the output data becomes
111011001000100101001001011001010, totaling 33 bits on top of the ADPCM coding process, reduced by 6 bits as compared with conventional ADPCM, that means the compression rate is increased by 15%, (39−33)/39=0.15.

Applying the variable length coding to the above example of EASS, with the increased compression rate, once the data storage capacity of the random access memory is enhanced, the buffering time can be extended. When the compressed data are retrieved from the random access memory, the compressed data are first decoded to the original ADPCM codes and then to the original audio signals for lossless audio output.

From the foregoing, the present invention mainly relies on the prognostic code converter to generate variable length codes according to the probability of occurrence of data bits, such that the bit string with the highest probability of occurrence will become the variable length code with the shortest length, and the bit string with lesser probability of occurrence will become the variable length code with longer length. Using this coding technique, the average number of bits in a data block can be substantially reduced and the compression rate can be enhanced accordingly. In the case of EASS, the data storage capacity of random access memory can be increased for extending the buffering time. Therefore, the output performance of the CD player can be improved.

The foregoing description of the preferred embodiments of the present invention is intended to be illustrative only and, under no circumstances, should the scope of the present invention be so restricted.

1. A method of optimizing the compression rate in adaptive differential pulse code modulation (ADPCM) by modifying the pulse code modulation process, wherein a prognostic code converter is used to generate variable length codes on top of the adaptive differential pulse code modulation (ADPCM) coding, such that codes of different lengths are assigned in accordance with the probability of occurrence of data bits, so as to reduce the compressed data size and to increase the compression rate of the conventional ADPCM coding.

2. The method of optimizing the compression rate in ADPCM as claimed in claim 1, wherein the prognostic code converter includes a variable length encoder and a variable length decoder, wherein
the variable length encoder is based on the probability of occurrence of data bits to convert regular ADPCM code to a new variable length code, whereby that the regular pulse code with the highest occurrence rate is assigned a variable length code with the shortest length, and the regular pulse code with lesser occurrence rate is assigned a new code with longer length, thus replacing the regular ADPCM codes; and
a variable length decoder works in conjunction with, the above variable length encoder, working in reverse order to convert the compressed data back to the pure ADPCM codes, and latter to the original audio signals for lossless audio output.

3. The method of optimizing the compression rate in ADPCM as claimed in claim 2, wherein the variable length encoder is based on the Huffman coding scheme to generate new codes in accordance with the probability of occurrence of data bits.
